(19) United States
(12) Patent Application Publication
(10) Pub. No.: US 2025/0356274 A1
(43) Pub. Date: Nov. 20, 2025

(54) ELECTRONIC DEVICE AND METHOD FOR HANDLING ERP DATA

(71) Applicant: Somprav Pareek, Beaverton, OR (US)

(72) Inventor: Somprav Pareek, Beaverton, OR (US)

(21) Appl. No.: 19/202,026

(22) Filed: May 8, 2025

Related U.S. Application Data
(60) Provisional application No. 63/647,653, filed on May 15, 2024.

(51) Int. Cl. G06Q 10/0631

(52) U.S. Cl. CPC G06Q 10/0631

(57) ABSTRACT

Embodiments herein provide a method for handling an ERP data. The method includes establishing, by a data population platform, a connection with at least one source electronic device in which at least one ERP application is executed. Further, the method includes establishing, by the data population platform, a connection with at least one target electronic device in which at least one ERP application is executed. Further, the method includes receiving, by the data population platform, a request including at least one user input from the at least one target electronic device to obtain the ERP data from the at least one source electronic device. Further, the method includes obtaining, by the data population platform, the ERP data from the at least one source electronic device based on the request. Further, the method includes sharing, by the data population platform, the ERP data to the at least one target electronic device.

### CROSS REFERENCE TO RELATED APPLICATION

This application is based on and derives the benefit of USPTO Provisional Application 63/647,653, the contents of which are incorporated herein by reference.

### TECHNICAL FIELD

Embodiments disclosed herein relate to the technical field of data processing method and system, and more particularly to an electronic device and a method for handling an Enterprise Resource Planning (ERP) data between a source electronic device and a target electronic device.

### BACKGROUND

Certain legal requirements (Companies laws and Rules in various countries) have mandated maintenance of certain data in electronic mode like books of accounts of a company on territorial basis for various purposes such as audit, subsequent reference and so on. So, there has been a need for a proper system for storage, retrieval, display or printout of electronic records which shall not be disposed of or rendered unusable, unless permitted by law.

There are a few reports available in the state of art about the existence of data extraction systems.

CN116361298B discloses a method and a device for automatically acquiring an SAP data to generate report form for an Enterprise Application Services (EAS). The method includes the following steps: synchronizing a financial voucher detail table, a subject balance table and a plurality of accounting statement version tables generated based on accounting statement versions created in an SAP system to a predetermined data storage system. Further, the method includes processing the data synchronized to the data storage system to obtain a plurality of data models, one of which comprises an accounting statement version number, a company code, an amount, a subject father node, a subject child node, a reporting period, a subject and a function range, and a relationship between the subject and an accounting statement item node, where the other information includes a cash flow code, a company code, a reporting period and an amount. Further, the method includes extracting results of the plurality of data models to an EAS report database to generate an intermediate table. In response to a report generation operation initiated by a user in an EAS combined report system, the method includes extracting data in the intermediate table to the EAS report template by utilizing a pre-written SQL code, and generating an EAS report.

US20220188279 discloses systems and methods for creating and tracking implementation of a consolidation of data during a migration from one or more source systems to one target system. The system includes a computing device, having a processor and a memory, and instructions stored in the memory that are executable by the processor wherein a set of software objects and their attributes are identified based on metadata of the target system, a first subset of the software objects is selected to identify information needing to be migrated from a first source system of the one or more source systems to the target system, and a second subset of the software objects is selected to identify information needing to be migrated from a first source system of the one or more source systems to the target system, and wherein the first and second subsets are merged together to form a merged subset.

But there is no technology providing a system and a method for extracting data from a source application, population of the extracted data in a target application and maintenance of the target application which are ERP based for various purposes of data processing. Also, particularly no prior art provides a system and method for extracting data from a selected source ERP application and populate a target ERP application of the same configuration for a regulatory compliance in some selected territories.

In an example, multinational corporation with offices in several territories worldwide is operating on the ERP application to manage its financial and compliance data. The company is required to comply with varying regulatory standards in each territory it operates. As part of its compliance processes, the company needs to extract data from the source ERP application, such as Systems Analysis Program Development (SAP), and populate a target ERP application in the same configuration to ensure all regulatory reporting and compliance requirements are met across multiple regions. While ERP systems are widely used for data management in businesses, there is no efficient technology available that offers a system and method to directly extract data from the selected ERP source application, populate it into a target ERP application, and maintain this target application for compliance purposes. Specifically, the company faces the following challenges such as the company's regulatory needs differ from a region to another region. Thus requires the customized extraction of data. Further, no existing solution provides an easy, automated way to extract the data from the ERP source application (e.g., financial or operational data) and populate the target ERP application (which could be a different module or region-specific configuration of

ERP) for regulatory compliance in selected territories. Further, the manual processes to transfer the data are error-prone, time-consuming, and fail to meet the dynamic needs of regulatory reporting.

Hence, there is a need for a system and a method of data extraction from the ERP based source application to an ERP based target application based on user requirements and population of the extracted data into the target application using a data extracting tool (or data population platform) for compliance purposes in a seamless and automated way.

### SUMMARY

Accordingly, the embodiments herein provide a method for handling an ERP data. The method includes establishing, by a data population platform, a connection with at least one source electronic device in which at least one ERP application is executed. Further, the method includes establishing, by the data population platform, a connection with at least one target electronic device in which at least one ERP application is executed. Further, the method includes receiving, by the data population platform, a request including at least one user input from the at least one target electronic device to obtain the ERP data from the at least one source electronic device. Further, the method includes obtaining, by the data population platform, the ERP data from the at least one source electronic device based on the request. Further, the method includes sharing, by the data population platform, the ERP data to the at least one target electronic device.

Accordingly, the embodiments herein provide an electronic device for handling ERP data. The electronic device includes a data population platform coupled with a processor and a processor. The data population platform is configured to establish a connection with at least one source electronic device in which at least one ERP application is executed. Further, the data population platform is configured to establish a connection with at least one target electronic device in which at least one ERP application is executed. Further, the data population platform is configured to receive a request comprising at least one user input from the at least one target electronic device to obtain the ERP data from the at least one source electronic device. Further, the data population platform is configured to obtain the ERP data from the at least one source electronic device based on the request. Further, the data population platform is configured to share the ERP data with the at least one target electronic device.

In an embodiment, the ERP data includes at least one of: an SAP data, an Oracle® ERP data, and a Microsoft® Dynamics data.

In an embodiment, the ERP application includes at least one of: an SAP application, an Oracle® ERP application, and a Microsoft® Dynamics application.

In an embodiment, further, the method includes synchronizing, by the data population platform, the ERP data between the at least one source electronic device and the at least one target electronic device. The synchronization is done based on the at least one user input to keep the at least one target application synchronized with the at least one source application for configuration, customization, enhancements, and manual configuration of the at least one target electronic device. The synchronizing is performed at least one of: a near-real time and a predefined time. Further, the method includes generating, by the data population platform, a report comprising the ERP data at the at least one target electronic device.

In an embodiment, further, the method includes determining, by the data population platform, a data parity in the report. Further, the method includes notifying, by the data population platform, a user about the data parity.

In an embodiment, the data population platform shares the ERP data to the at least one target electronic device prior to the at least one target electronic device is configured by computing a size of the ERP data based on the at least one user input for data filtration from the at least one source electronic device.

In an embodiment, obtaining, by the data population platform, the ERP data from the at least one source electronic device based on the request includes determining, by the data population platform, a filtering criteria associated with the at least user input, determining, by the data population platform, a frequency of accessing the at least one source electronic device, determining, by the data population platform, at least one compatibility of operating the at least one source electronic device with the at least one target electronic device, obtaining, by the data population platform, the ERP data from the at least one source electronic device upon determining the filtering criteria associated with the at least user input, a frequency of accessing the at least one source electronic device, and at least one compatibility of operating the at least one source electronic device with the at least one target electronic device.

In an embodiment, the at least one user input corresponds to obtain a subset ERP data from a complete ERP data. In another embodiment, the at least one user input corresponds to obtain a complete ERP data from the at least one ERP application.

In an embodiment, the at least one source electronic device includes at least one of: a main productive source electronic device, a disaster recovery system, a fail over system, high availability source electronic device. The at least one target electronic device is active or read only.

In an embodiment, the at least one SAP application corresponds to at least one of: an SAP ERP, SAP S/4HANA, an SAP Business One, an SAP Business ByDesign, SAP SuccessFactors, SAP Ariba, SAP Concur, SAP Hybris, SAP Analytics Cloud, SAP Leonardo, SAP Fiori, SAP BW/4HANA, SAP NetWeaver, SAP ECC, an SAP S/4 On-premises, SAP S/4 on private Cloud and SAP S/4 on public cloud.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIG. 1 describes a simplified block diagram of a system for handling a set of ERP data between a source electronic device and a target electronic device, based on at least one user input, according to embodiments as disclosed herein;

FIG. 2 depicts a block diagram of another system, for populating the set of ERP data of interest from multiple source electronic devices to a single target electronic device via a data population platform executing in an electronic device, according to embodiments as disclosed herein;

FIG. 3 depicts a block diagram of another system, for populating the set of ERP data of interest from a single source electronic devices to multiple target electronic devices via the data population platform executing in the electronic device, according to embodiments as disclosed herein;

FIG. 4 depicts a block diagram of another system, for populating the set of ERP data of interest from multiple source electronic devices to multiple target electronic devices via the data population platform executing in the electronic device, according to embodiments as disclosed herein;

FIG. 5 is a block diagram depicting various elements of the source electronic device, according to embodiments as disclosed herein;

FIG. 6 is a block diagram depicting various elements of the target electronic device, according to embodiments as disclosed herein;

FIG. 7 illustrates the block diagram of various elements of the electronic device, according to embodiments as disclosed herein;

FIG. 8 is a block diagram depicting various components (or elements) of the data population platform, useful for handling the set of ERP data between the source electronic device and the target electronic device, according to embodiments as disclosed herein;

FIG. 9A depicts an example system for populating the set of ERP data of interest by the data population platform, using one or more additional intermediate data filtration engines, according to embodiments as disclosed herein;

FIG. 9B depicts an example block diagram of a system for handling ERP data in an ERP S/4 could based environment, according to embodiments as disclosed herein;

FIG. 10A and FIG. 10B depict a method implemented, by a data population platform, for obtaining a set of ERP data of interest to be populated from the source electronic device to the target electronic device, according to embodiments as disclosed herein; and

FIGS. 11A-11B depict examples tables for the ERP data populated at the target electronic device based on user input, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

In this specification “source entity” and “source electronic device” are analogous. In this specification “target entity” and “target electronic device” are analogous. Further, in this specification “a set of data”, and “a set of ERP data” are used interchangeably.

The embodiments herein achieve a method for handling an ERP data. The method includes establishing, by a data population platform, a connection with at least one source electronic device in which at least one ERP application is executed. Further, the method includes establishing, by the data population platform, a connection with at least one target electronic device in which at least one ERP application is executed. Further, the method includes receiving, by the data population platform, a request including at least one user input from the at least one target electronic device to obtain the ERP data from the at least one source electronic device. Further, the method includes obtaining, by the data population platform, the ERP data from the at least one source electronic device based on the request. Further, the method includes sharing, by the data population platform, the ERP data to the at least one target electronic device.

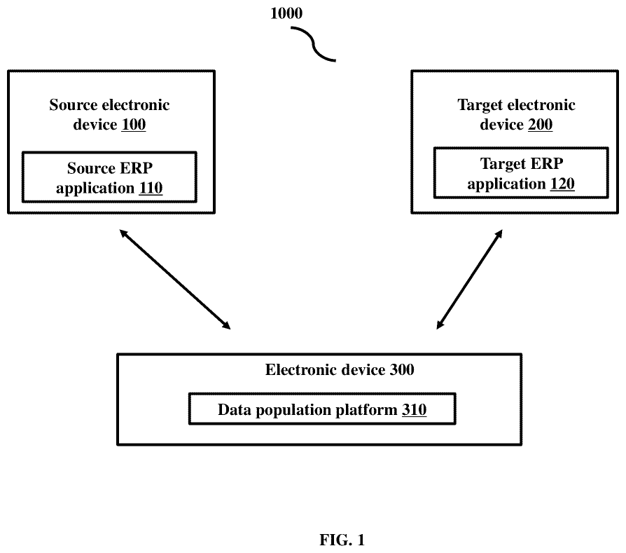

Referring now to the drawings, and more particularly to FIGS. 1 through 11B, where similar reference characters denote corresponding features consistently throughout the figures, there are shown embodiments.

FIG. 1 describes a simplified block diagram of a system 1000, for handling a set of ERP data between a source electronic device 100 and a target electronic device 200, based on at least one user input, according to embodiments as disclosed herein. In an embodiment herein, the system 1000 may comprise a source electronic device 100, a target electronic device 200, and an electronic device 300, wherein the electronic device 300 includes a data population platform 310. In an embodiment herein, the source electronic device 100 can be a source ERP device in which a source ERP application 110 is executed. Further, the target electronic device 100 can be a target ERP device in which a target ERP application 120 is executed. The ERP data includes at least one of: an SAP data, an Oracle® ERP data, and a Microsoft® Dynamics data. The ERP application includes at least one of: an SAP application, an Oracle® ERP application, and a Microsoft® Dynamics application. In an embodiment herein, the source electronic device 100, the target electronic device 200, and the electronic device 300 are communicably connected to each other through a network (not shown) or a server (not shown). In an example embodiment herein, the network can be at least one of a fourth generation (4G) network, a fifth generation (5G) network and a sixth generation (6G) network. Further, in an example embodiment herein, the network can include at least one of an Internet, a wireless network (a Wireless Fidelity (Wi-Fi) network, a cellular network, a Wi-Fi Hotspot, Bluetooth, Zigbee and so on using Wireless Application Protocol), a direct interconnection, and so on. Further, in an example embodiment herein, the network can include a wired network (a Local Area Network (LAN), a Controller Area Network (CAN) network, a Universal Asynchronous Receiver/Transmitter (UART), a bus network, Ethernet and so on), and so on.

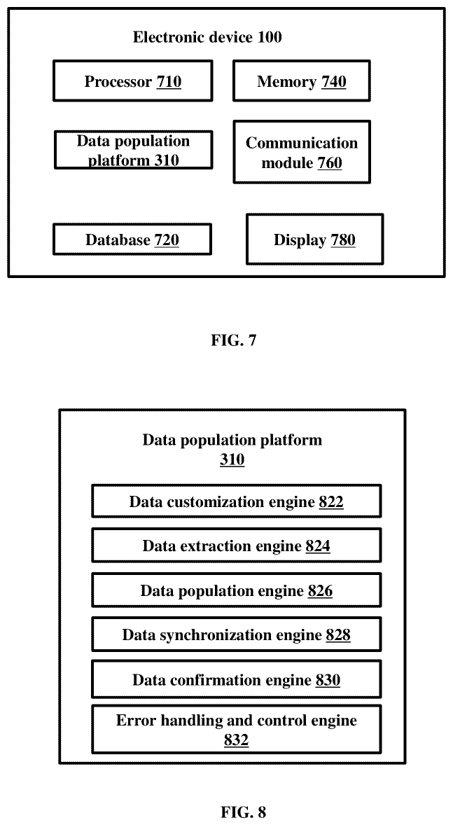

In an embodiment herein, the electronic device 300 further can comprise, a processor 710 and a memory 740 (as shown in FIG. 7). The source electronic device 100, the target electronic device 200 and the electronic device 300 can be, for example, but not limited to a portable electronic device, such as a portable computer, a computing device, a laptop, a smart phone, a desktop computer, a notebook, a Device-to-Device (D2D) device, a vehicle to everything (V2X) device, a foldable phone, a smart TV, a tablet, an immersive device, and an internet of things (IoT) device or the like. In an embodiment herein, the electronic device 300 can include functionality for communicating with the data population platform 310 through a communication module 760 (as shown in FIG. 7). Further, in an example embodiment, the electronic device 300 can be a Smart Phone (e.g., iphone, Android phone, and Windows phone), a conventional web-enabled portable computer, a tablet computer or another device capable of connecting through the data population platform 310 to the source electronic device 100 and the target electronic device 200.

The processor 710 may be a computing unit performing general operations of the electronic device 300. Further, the processor 710 may control an operation of the data population platform 310. Further, the processor 710 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 710 may include multiple cores and is configured to execute the instructions stored in the memory 740.

Further, the processor 710 is configured to execute instructions stored in the memory 740 to perform various processes. The memory 740 also stores instructions to be executed by the processor 710. The memory 740 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 740 may, in some examples, be considered a non-transitory storage medium. The term “non-transitory” may indicate that the storage medium is not embodied in a carrier wave or a propagated signal. However, the term “non-transitory” should not be interpreted that the memory is non-movable. In certain examples, a non-transitory storage medium may store data that can, over time, change (e.g., in Random Access Memory (RAM) or cache).

In an example embodiment herein, the data population platform 310 of the electronic device 300, can receive a user input from the target electronic device 200, on a set of ERP data to be populated to the target electronic device 200. Based on the user input, the data population platform 310 can determine the source electronic device 100 for data extraction. In an example embodiment, the data population platform 310, can extract the requested set of ERP data from the source electronic device 100, wherein the data population platform 310 can establish connection with the source electronic device 100 for extracting the requested data. In an embodiment herein, the data population platform 310 can establish connection with the source ERP application 110 executed by a processor 510 (as shown in FIG. 5) in the source electronic device 100. In an example embodiment herein, the data population platform 310 can extract the requested ERP data from the source electronic device 100 using the source ERP application 110, by virtue of the established connection. In an example embodiment herein, the user input received by the data population platform 310, further, may include a user-specified frequency for accessing the source electronic device 100 for extraction of the data of interest, in near real-time or at a pre-defined time.

In an example embodiment herein, the ERP data to be extracted may include comprehensive enterprise resource planning (CERP) data of the ERP. Further, in an example embodiment herein, the CERP data may be at least one of, financial accounting data, controlling data, materials management data, sales and distribution data, human resources data, S/4 HANA customer experience data, S/4 HANA sales data, S/4 HANA service data, S/4 HANA marketing data, S/4 HANA commerce data, and S/4 HANA customer data management data, and so on.

In another example, the at least one SAP application corresponds to at least one of: an SAP ERP, SAP S/4HANA, an SAP Business One, an SAP Business ByDesign, SAP SuccessFactors, SAP Ariba, SAP Concur, SAP Hybris, SAP Analytics Cloud, SAP Leonardo, SAP Fiori, SAP BW/4HANA, SAP NetWeaver, SAP ECC, an SAP S/4 On-premises, SAP S/4 on private Cloud and SAP S/4 on public cloud. The ERP application corresponds to an Oracle NetSuite. The Microsoft® Dynamics application corresponds to Dynamics 365 Finance, Dynamics 365 Supply Chain Management, Dynamics 365 Business Central, and Dynamics 365 Commerce, Dynamics 365 Sales, Dynamics 365 Customer Service, Dynamics 365 Field Service, Dynamics 365 Marketing, and Dynamics 365 Project Service Automation. The dynamics 365 finance focuses on financial management, accounting, and reporting. The Dynamics 365 supply chain management helps businesses manage their entire supply chain, from planning to execution. The dynamics 365 business central is a cloud-based ERP (Enterprise Resource Planning) system for small to medium-sized businesses. The Dynamics 365 Commerce is designed for retail businesses, offering features for managing online and offline stores. The Dynamics 365 Sales helps businesses manage their sales processes, including lead management, opportunity tracking, and forecasting. The Dynamics 365 Customer Service helps businesses manage customer interactions and provide support. The Dynamics 365 Field Service helps businesses manage field service operations. The Dynamics 365 Marketing helps businesses manage their marketing campaigns. The Dynamics 365 Project Service Automation helps businesses manage project-based services.

SAP S/4HANA: The next-generation enterprise resource planning (ERP) suite that runs on SAP HANA, SAP's in-memory database. It simplifies business processes and integrates data analytics into daily business operations. SAP Business One: A more simplified ERP solution designed for small and medium-sized enterprises (SMEs). It covers financials, operations, and customer relations, and it's relatively easier to implement than larger SAP solutions.

SAP Business ByDesign: A cloud-based ERP solution for mid-market businesses. It's designed for companies that need a more agile, scalable system and are looking for a software-as-a-service (Saas) solution.

SAP SuccessFactors: A cloud-based human resources (HR) management software that covers areas such as employee experience, performance management, recruitment, and more. SAP Ariba: A procurement and supply chain management platform that allows businesses to manage their supply chain, procurement processes, and supplier relationships.

SAP Concur: A travel and expense management solution designed to help businesses automate and streamline their travel booking and expense reporting processes. SAP Hybris: A suite of customer engagement and commerce solutions that help businesses manage e-commerce, marketing, and customer service activities. It's widely used for omnichannel retail strategies.

SAP Analytics Cloud: A cloud-based business intelligence (BI) and analytics platform that provides data visualization, reporting, and predictive analytics capabilities. SAP Leonardo: A digital innovation system that integrates advanced technologies like IoT (Internet of Things), machine learning, and blockchain to help businesses digitally transform.

SAP Fiori: A design system that provides a user-friendly, responsive interface for SAP applications, enhancing the user experience (UX) across devices. SAP BW/4HANA: A data warehousing solution that helps businesses consolidate and analyze large amounts of structured data, leveraging the power of the SAP HANA in-memory database. SAP NetWeaver—A technology platform that integrates data, processes, and applications for SAP solutions.

The above listed SAP application are just a few examples, and the SAP application offers numerous other products and solutions tailored to various business needs and industries.

Further, in an example embodiment, the connection between the source electronic device 100 and the data population platform 310, is established by inputting connection details such as without limitation, a hostname, user credentials, and data population processor details and setting up authorization with the source electronic device 100 in order to access data. Further, the data population platform 300 can extract the set of ERP data from the source electronic device 100, by applying a filtering criteria to a set of stored ERP data at the source electronic device 100, based on the user input. The filtering criteria can be, for example, slicing by data, country, functionality or organization element. In an example embodiment herein, extracting the set of ERP data from the source electronic device 100 may correspond to obtaining a subset of ERP data from a complete set of stored ERP data at the source electronic device 100. In another example, extracting the set of ERP data from the source electronic device 100 may correspond to obtaining the full set of ERP data from the complete set of stored ERP data at the source electronic device 100.

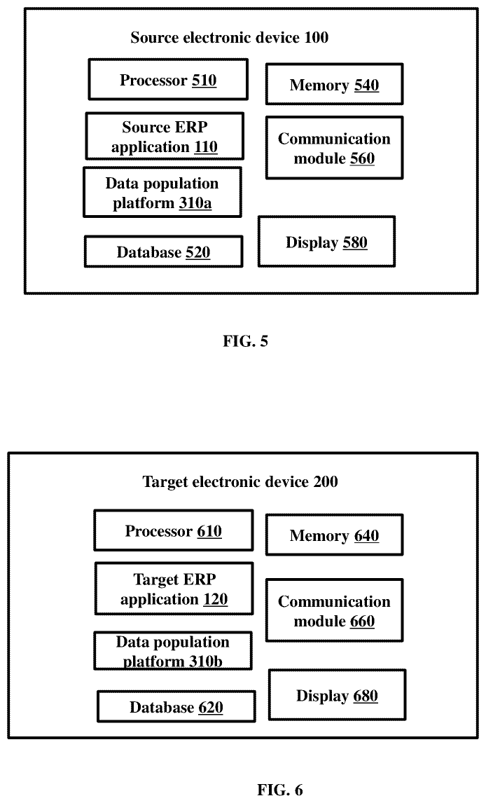

In an embodiment herein, the data population platform 310 can populate the extracted ERP data to the target electronic device 200, in which at least one target ERP application 120 is executed. In an example embodiment herein, the data population platform 310 can establish connection with the target electronic device 200, so that the data population platform 310 is compatible to populate the set of extracted ERP data to the database (not shown) of the target electronic device 200 and can perform population of the extracted ERP data. Further, in an example embodiment herein, configuration of the target electronic device 200 can be updated or modified by a processor 610 (as shown in FIG. 6) of the target electronic device 200, to accept the set of extracted ERP data from the source electronic device 100, depending upon the user input. Further, based on user requirement or need, a process is set up to keep the target electronic device 200 synchronized with the source electronic device 100 for configuration, customization, enhancements, and manual configuration using the data population platform 310. In an embodiment, configuration, customization, enhancements, and manual configuration of the at least one target electronic device corresponds to types of changes within the ERP are part of these bucketed items change in configuration, or customization (small development) enhancements adding or extending functionality of an existing SAP functionality. Manual configuration is where manually changes are done i.e., change in number range, closing period updated or the like.

In an embodiment herein, the data population engine 310 can determine data parity between the requested ERP data from the source electronic device 100 and populated ERP data to the target electronic device 200. Further, the data population engine 310 can notify a user about the data parity by generating an alert.

In an example, the data population platform 310 ensures seamless synchronization of ERP data between the source electronic device 100 and the target electronic device 200. This synchronization is triggered by the user input, ensuring that the target device 200 remains consistent with the source device 100 in terms of configuration, customization, enhancements, and manual settings. The platform 310 also performs the data parity check to verify that the data between the two devices 100 and 200 is aligned. If any discrepancies are found, the platform 310 notifies the user, ensuring that both devices 100 and 200 maintain accurate and synchronized data for efficient application performance. The data parity check could be extended to other scenarios such as device management, app updates, or system configurations across the devices 100 and 200.

Further, the data population platform 310 shares the ERP data to the target electronic device 200 prior to the target electronic device 200 is configured by computing a size of the ERP data based on the user input for data filtration from the source electronic device 100. In an example, if the size of the ERP data is 1 GB at the source electronic device 100 then, the data population platform 310 assigns the space for 1 GB in the target electronic device 200 and shares the ERP data to the target electronic device 200 form the source electronic device 100.

The present invention in various embodiments discloses the systems 1000-4000 for the data extraction and population from the source electronic device 100 (e.g., source ERP system) to the target electronic device 200 (e.g., target ERP system). Further, the system 1000 may include one or more server, a third party provider and other entities useful for handling the ERP data.

In an implementation, the source electronic device 100 may contain a huge database out of which a certain subset required by the user is to be filtered, populated and maintained in the source electronic device 100, using various engines as described earlier (explained in FIG. 8). In an implementation, the data population platform 310 is configured to extract the data based on ERP version of the source ERP application 110 and to ensure compatibility between them to aid the data extraction.

In another implementation, the data population platform 310 further can be configured to receive the user inputs based on which the set of data to be extracted from the source ERP application 110 is filtered and the frequency in which it needs to be operated is determined.

In an embodiment, the data population platform 310 can be configured to establish the connection between the source ERP application and the data population platform 310 such that it is compatible to receive the data of interest from the source ERP application 110 based on a user defined criteria and to schedule the frequency in which the data extraction should happen and to execute the extraction of data.

In an embodiment, the data population platform 310 can be configured to establish a connection between the target ERP application 120 over the network, and the data population platform 310 such that it is compatible to populate the data of interest to the database 620 of the target electronic device 200 and to perform the population of extracted data. A target ERP application configuration will be updated to accept the data from the source electronic device 100 depending upon user defined criteria. Based on the user requirement a process is setup to keep the target application synchronized with the source application for configuration, customization, enhancements, and manual configuration using the data synchronization module. Depending on the user requirement, the database 620 can be set to active or read only.

Embodiments herein disclose the network selected from cloud, ERP on premise, or the like. A connectivity is established between the source ERP application 100, the data population platform 310 and the target ERP application 120 using one or more engines of the data population platform 310 (explained in FIG. 8). The target ERP application 120 can be always the same version of the source ERP application 110. The type of connectivity depends on the location of the target ERP application 120.

Embodiments herein, disclose data population platform 310 can be configured to generate custom control reports to confirm the data parity between the source ERP application 110 and the target ERP application 120 to automate the alerting mechanism in case of any data parity issues or discrepancy.

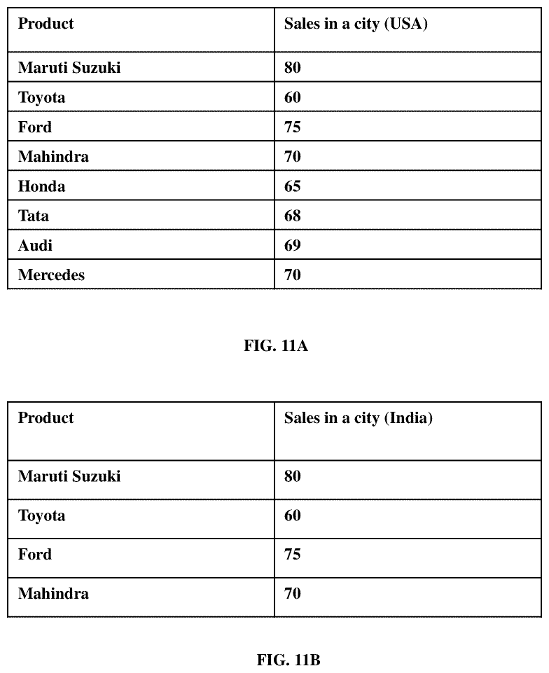

Further, an example for handling the ERP data is explained in FIG. 11A and FIG. 11B.

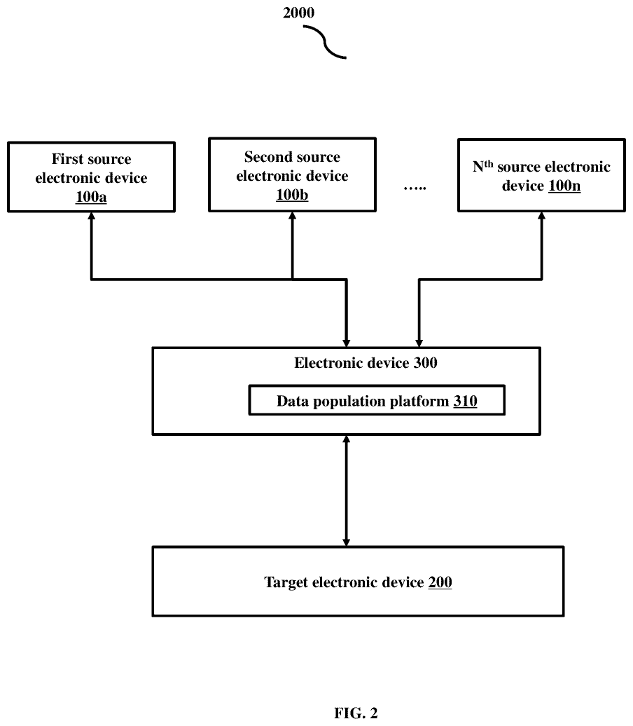

FIG. 2 depicts the block diagram of another system 2000, for populating the set of data of interest from multiple source electronic devices (100a, 100b, . . . , 100n) to the single target electronic device 200 via the data population platform 310 executed in the electronic device 300, according to embodiments as disclosed herein. The system 2000 may comprise a plurality of source electronic devices 100a, . . . ,100n, the target electronic device 200 and the electronic device 300. In an embodiment herein, the plurality of source electronic devices 100a, . . . ,100n, the target electronic device 200 are communicably connected to the electronic device 200 through the network. The network can be at least one of the 4G network, the 5G network and the 6G network, wherein the network can include the same elements as described earlier in FIG. 1. In an embodiment herein, the data population platform 310 can establish connectivity with the source electronic device 100 and the target electronic device 200, in order to extract the set of ERP data from the source electronic device 100 and populate them to the target electronic device 200. In an example embodiment herein, each of the plurality of source electronic devices 100a, 100b, . . . , 100n can be located at different locations within a territory and the target electronic device 200 can be located in a different territory. Further, in an example embodiment herein, each of the plurality of source electronic devices (100a, 100b, . . . , 100n) can be located at different territories and the target electronic device 200 can be located in other territory. Further, in an example embodiment herein, each of the plurality of source electronic devices (100a, 100b, . . . , 100n) and the target electronic device 200 can be located at different locations within a territory.

Consider an example, the data population platform 310 establishes connections with multiple source electronic devices 100a, 100b, and 100c, each running at least one ERP application. These devices 10a-100c are located in different countries: device 100a is in the USA, device 100b is in the UK, and device 100c is in Germany. Additionally, the platform 310 connects to the target electronic device 200 in India, where at least one ERP application is also executed.

The platform 310 then receives the user request from the target electronic device 200, which includes user input specifying the need to obtain sales data for car manufacturing in 2024. This request is processed by the platform 310, which identifies the relevant ERP data across the source devices located in the USA, UK, and Germany. Based on this user request, the data population platform 310 retrieves the necessary ERP data from the multiple source devices 100a, 100b, and 100c and shares the data with the target electronic device 200 in India. This ensures that the target device receives the most up-to-date and relevant sales data, facilitating accurate analysis and decision-making for the user.

In an embodiment, the synchronization of the ERP data is performed in a near-real time. In another embodiment, the synchronization of the ERP data is performed at a predefined time.

In a near-real-time synchronization scenario, the ERP data is continuously updated and synchronized between the source and target applications 110 and 120 with minimal delay, ensuring that the target system reflects changes made in the source system almost immediately. For example, in a global company with multiple departments or locations, the ERP data on the source application (e.g., inventory levels, sales figures, or employee information) can be updated frequently due to changing market conditions, new transactions, or business operations.

As soon as any update occurs in the source ERP application, such as a new sales order being processed, inventory being restocked, or employee data being modified. A data synchronization engine 828 (as shown in FIG. 8) automatically detects these changes. The data synchronization engine 828 quickly processes the changes and synchronizes the relevant data to the target ERP application, such as a mobile device used by a sales representative or a warehouse management system.

For instance, if a warehouse in California updates its stock quantity for a product in the ERP system, that updated data is reflected in near real-time on the target device used by the inventory manager in New York. This ensures that both the source and target devices always have the most current data, reducing the risk of discrepancies and enabling more accurate decision-making, quicker responses to changes, and better overall coordination across departments and locations. The near-real-time synchronization ensures the data is always aligned without significant delays, improving business efficiency and operational effectiveness

Further, the operations and the functions of the plurality of source electronic devices 100a, . . . , 100n, the target electronic device 200 and the electronic device 300 are already explained in FIG. 1. For the sake of brevity, we are not repeating the same operation in the patent disclosure.

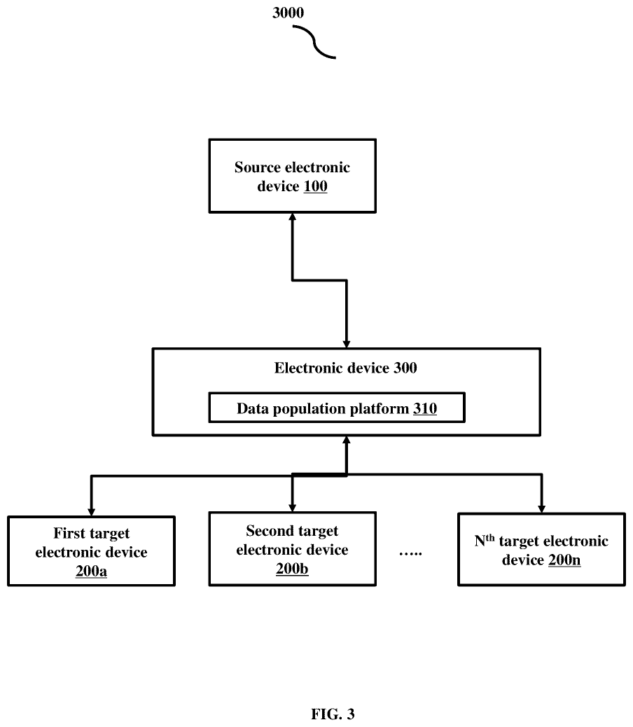

FIG. 3 depicts the block diagram of another system 3000, for populating the set of data of interest from the single source electronic device 100 to multiple target electronic devices 200a, 200b, . . . 200n via the data population platform 310 running in the electronic device 300, according to embodiments as disclosed herein. The system 3000 may comprise the source electronic device 100, the electronic device 300, and the plurality of target electronic devices 200a, 200b, . . . 200n. In an embodiment herein, the source electronic device 100 and the plurality of target electronic devices 200a, . . . ,200n are communicably connected to the electronic device 300 through the network.

In an embodiment herein, the data population platform 310 can establish connectivity with the source electronic device 100 and the target electronic device 200, in order to extract the set of ERP data from the source electronic device 100 and populate them to the plurality of target electronic devices 200a, . . . ,200n. In an example embodiment herein, each of the plurality of target electronic devices 200a, 200b, . . . ,200n can be located at different locations within a territory and the source electronic device 100 can be located in a different territory. Further, in an example embodiment herein, each of the plurality of target electronic devices 200a, 200b, . . . ,200n can be located at different territories and the source electronic device 100 can be located in other territory. Further, in an example embodiment herein, each of the plurality of target electronic devices 200a, 200b, . . . ,200n and the source electronic device 100 can be located at different locations within a territory.

The data population platform 310 establishes the connection with the source electronic device 100 located in California, USA, where at least one ERP application is executed. Additionally, the platform 310 connects to the plurality of target electronic devices 200a, 200b, and 200c, each also running an ERP application. These target devices 200a-200c are located in different countries: device 200a is in New York, USA, device 200b is in the UK, and device 200c is in India. The platform 310 then receives a request, including user input, from the target devices 200a-200c. The user input specifies a need to obtain the ERP data related to employees with expertise in automation or machine learning within the IT industry. This request is processed by the platform 310, which identifies and retrieves the relevant employee data from the source electronic device 100 in California. Based on the request, the data population platform 310 gathers the ERP data from the source device 100 and shares it with the target devices 200a, 200b, and 200c located in the USA, UK, and India, respectively. This ensures that all target devices 200a, 200b, and 200c receive the required employee data, enabling users in different locations to access the same relevant and up-to-date information for analysis or decision-making.

In an embodiment, the synchronization of the ERP data is performed in a near-real time. In another embodiment, the synchronization of the ERP data is performed at a predefined time.

Further, the operations and the functions of the source electronic devices 100, the plurality of the target electronic device 200a-200c and the electronic device 300 are already explained in FIG. 1. For the sake of brevity, we are not repeating the same operation in the patent disclosure.

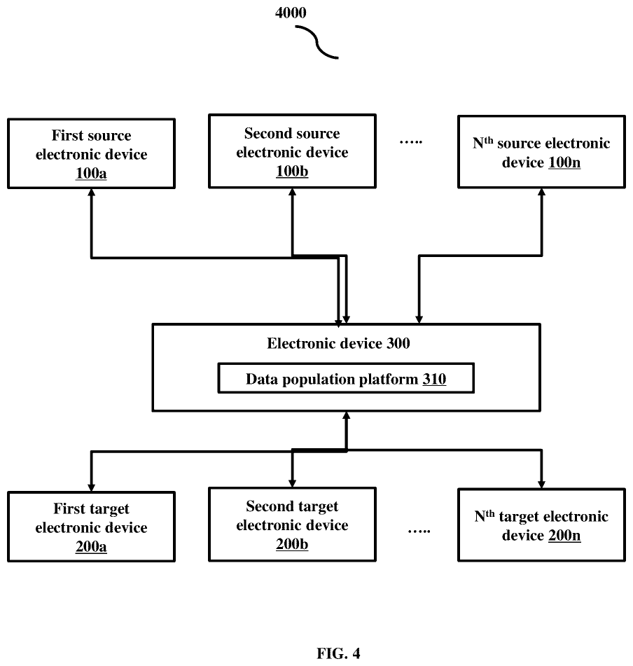

FIG. 4 depicts the block diagram of the system 4000 for populating the set of data of interest from multiple source electronic devices (100a, 100b, . . . ,100n) to multiple target electronic devices (200a, 200b, . . . ,200n) via the electronic device 300, according to embodiments as disclosed herein. The system 4000 may include the plurality of source e electronic devices 100a, 100b, . . . ,100n, the electronic device 300, and the plurality of target electronic devices 200a, 200b, . . . 200n. In an embodiment herein, the plurality of source electronic devices 100a, 100b, . . . ,100n and the plurality of target electronic devices 200a, . . . ,200n are communicably connected to the electronic device 300 through the network. In an embodiment herein, the data population platform 310 can establish connectivity with the plurality of source electronic devices 100a, 100b, . . . ,100n and the plurality of target electronic devices 200a, 200b, . . . 200n, in order to extract the set of ERP data from one or more of the plurality of the source electronic device 100 and populate them to one or more of the plurality of target electronic devices 200a, . . . ,200n. In an example embodiment herein, each of the plurality of the source electronic devices 100a, 100b, . . . , 100n can be located at different territorial areas. Further, each of the plurality of target electronic devices 200a, 200b, . . . ,200n can be located at different territorial locations.

In another example, each of the plurality of the source electronic devices 100a, 100b, . . . ,100n can be located at same territorial areas. Further, each of the plurality of target electronic devices 200a, 200b, . . . ,200n can be located at same territorial locations.

In an embodiment, the synchronization of the ERP data is performed in a near-real time. In another embodiment, the synchronization of the ERP data is performed at a predefined time.

Further, the operations and the functions of the source electronic devices 100a-100c, the plurality of the target electronic device 200a-200c and the electronic device 300 are already explained in FIG. 1. For the sake of brevity, we are not repeating the same operation in the patent disclosure.

Although FIG. 1 to FIG. 4 shows various hardware components of the systems 1000-4000 but it is to be understood that other embodiments are not limited thereon. In other embodiments, the systems 1000-4000 may include less or more number of components. Further, the labels or names of the components are used only for illustrative purposes and does not limit the scope of the invention. One or more components can be combined together to perform the same or substantially similar function in the systems 1000-4000.

FIG. 5 illustrates a block diagram of various elements of the source electronic device 100. In an example embodiment herein, the source electronic device 100 may comprise the processor 510, the source ERP application 110, a database 520, the memory 540, the communication module 560, and a display 580. The processor 510 is coupled with the source ERP application 110, the database 520, the memory 540, the communication module 560, and the display 580.

In an example embodiment herein, the source electronic device 100 can be without limitation any of the following:
i. A main productive source electronic device, such as a main productive instance ERP device which is actively being used by users to record transactions.
ii. A disaster recovery electronic device, such as a Disaster recovery ERP device which is synchronized with the main system on near real-time.
iii. A high availability source electronic device such as a High Availability ERP electronic device, which is synchronized with the main system.
iv. A fail over source electronic device such as clustered or fail over ERP electronic device which is synchronized with the main system.

Further, in an example, the source electronic device 100 may be of any ERP transaction processing electronic device such as but not limited to, ERP ECC electronic device, ERP S/4 electronic device On-premises, ERP S/4 electronic device on private Cloud and ERP S/4 electronic device on public cloud.

In an embodiment, the communication module 560 includes an electronic circuit specific to a standard that enables wired or wireless communication. In an example embodiment herein, the communication module (560) may include at least one of the Internet, a wired network (e.g., LAN, CAN, UART, bus network, Ethernet and so on), a wireless network (e.g., Wi-Fi network, cellular network, a Wi-Fi Hotspot, Bluetooth, Zigbee and so on using Wireless Application Protocol), a direct interconnection, and so on.

In an example embodiment herein, the processor 510 may be a processor performing general operations of the source electronic device 100. Further, the processor 510 may control operation of the source ERP application 110. Further, the processor 510 may include one or a plurality of processors. The one or the plurality of processors may be a general-purpose processor, such as a CPU, an AP, or the like, a graphics-only processing unit such as a graphics processing unit (GPU), a visual processing unit (VPU), and/or an AI-dedicated processor such as a neural processing unit (NPU). The processor 510 may include multiple cores and is configured to execute the instructions stored in the memory 540.

Further, the processor 510 is configured to execute instructions stored in the memory 540 to perform various processes. The memory 540 also stores instructions to be executed by the processor 510. The memory 540 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 540 may, in some examples, be considered a non-transitory storage medium. The term “non-transitory” may indicate that the storage medium is not embodied in a carrier wave or a propagated signal. However, the term “non-transitory” should not be interpreted that the memory is non-movable. In certain examples, a non-transitory storage medium may store data that can, over time, change (e.g., in Random Access Memory (RAM) or cache).

In an example embodiment herein, the set of ERP data to be extracted by the data population engine 310, using the source ERP application 110, can be stored in the database 520. In an embodiment, the display 580 can be part of the source electronic device 100, such as display unit of a smart phone or a tablet computer or a laptop etc. Further, in another embodiment, the display unit can be configured as a stand-alone display unit communicatively coupled with the source electronic device 100 for displaying data and characters of the user input and an output. In an embodiment, the display unit can be one of variety of available LCD (Liquid-Crystal Display) display unit, LED (Light-Emitting Diode) display unit, and so on.

Although FIG. 5 shows various hardware components of the source electronic device 100 but it is to be understood that other embodiments are not limited thereon. In other embodiments, the source electronic device 100 may include less or more number of components. Further, the labels or names of the components are used only for illustrative purposes and does not limit the scope of the invention. One or more components can be combined together to perform the same or substantially similar function in the source electronic device 100.

FIG. 6 illustrates the block diagram of various elements of the target electronic device 200, according to embodiments as disclosed herein. In an example embodiment herein, the target electronic device 200 can include the target ERP application 120, the processor 610, a database 620, a memory 640, a communication module 660, and a display 680. The processor 610 is coupled with the target ERP application 120, the data population platform 310b, the database 620, the memory 640, the communication module 660, and the display 680.

In an embodiment herein, operational and functional features of the processor 610, the database 620, the memory 640, the communication module 660, and the display 680 are same as the processor 510, the database 520, the memory 540, the communication module 560, and the display 580, respectively as described for FIG. 5. For the sake of brevity, we are not repeating the same operation in the patent disclosure.

In an example embodiment, the data population platform 310b may receive the user input regarding the set of ERP data to be extracted from the source ERP application 110. Further, the data population platform 310 can configure the target ERP application 120, by calculating size of the set of ERP data extracted based on the user input, in order to populate them in the target electronic device 200.

Further, the data population engine 310b can update configuration of the target ERP application 120 to enable accepting data from the source ERP application 110 in order to populate them to the database 620, based on the user input. The data population engine 310b may assist to synchronize the target ERP application 120 with the source ERP application 110 for configuration, customization, enhancements, and manual configuration.

Further, the data population engine 310b may determine any data parity between the source ERP application 110 and the target ERP application 120, and can generate the custom control reports to confirm the data parity. Further, the data population engine 310b can automate an alerting mechanism in case of any data parity issues between the source ERP application 110 and the target ERP application 120.

Although FIG. 6 shows various hardware components of the target electronic device 200 but it is to be understood that other embodiments are not limited thereon. In other embodiments, the target electronic device 200 may include less or more number of components. Further, the labels or names of the components are used only for illustrative purposes and does not limit the scope of the invention. One or more components can be combined together to perform the same or substantially similar function in the target electronic device 200.

FIG. 7 illustrates the block diagram of various elements of the electronic device 300, according to embodiments as disclosed herein. In an example embodiment herein, the electronic device 300 can include the processor 710, the data population platform 310, a database 720, a memory 740, a communication module 760, and a display 780. The processor 710 is coupled with the target ERP application 720, the data population platform 310, the database 720, the memory 740, the communication module 760, and the display 780.

In an embodiment herein, operational and functional features of the processor 710, the database 720, the memory 740, the communication module 760, and the display 780 are same as the processor 510, the database 520, the memory 540, the communication module 560, and the display 580, respectively as described for FIG. 5. For the sake of brevity, we are not repeating the same operation in the patent disclosure.

Although FIG. 7 shows various hardware components of the electronic device 300 but it is to be understood that other embodiments are not limited thereon. In other embodiments, the target electronic device 300 may include less or more number of components. Further, the labels or names of the components are used only for illustrative purposes and does not limit the scope of the invention. One or more components can be combined together to perform the same or substantially similar function in the electronic device 300.

FIG. 8 illustrates a block diagram of various components of the data population platform 310 useful for handling the set of ERP data between the source electronic device 100 and the target electronic device 200, according to embodiments as disclosed herein. In an embodiment herein, based on the received user input, the data population platform 310 can extract the set of ERP data from the source electronic device 100 and populate them to the target electronic device 200. In an example embodiment herein, the data population platform may comprise a data customization engine 822, a data extraction engine 824, a data population engine 826, a data synchronization engine 828, a data confirmation engine 830, and an error handling and control engine 832.

In an example embodiment, the customization engine 522 of the data population platform 310 can be configured by the processor 710 to establish receive the request comprising at least one user input for the set of ERP data to be populated in a timely manner such as in near-real time or in a pre-defined time, to the target electronic device 200 in which a target ERP application 120 is executed. The data customization module 822 receives the user inputs based on which the set of data to be extracted from the source ERP application is filtered and the frequency in which it needs to be operated is determined.

In other words, the data customization module 822 receives the user inputs to customize the data extraction process from the source ERP application. Based on the inputs, the data customization module 822 filters the specific set of data to be extracted according to the user's needs. For instance, the user may request data related to employee performance, sales records, or inventory levels. Additionally, the data customization module 822 also receives instructions on the frequency with which the data extraction should occur, such as daily, weekly, or monthly.

For example, the user could input a request to extract sales data for the past month from the ERP application, to be updated every week. The data customization module 822 processes these inputs, filters the relevant sales data, and sets up the extraction frequency to run on a weekly schedule. This ensures that the data extraction is tailored to the user's requirements, both in terms of the data set and the frequency, optimizing the process for ongoing reporting or analysis.

Further, the data extraction engine 524 can determine the source electronic device 100 to extract the ERP data based on the user input. In an example embodiment, the data extraction engine 524 can be configured by the processor 710 to establish the connection between the source electronic device 100 in which the source ERP application is executed, and the data population platform 310, in order to extract ERP data.

In other words, the data extraction engine 524 establishes the seamless connection between the source ERP application and the data population platform 310. This connectivity ensures that the data extraction engine 524 is fully compatible with the ERP application, enabling it to receive specific data based on user-defined criteria. For instance, the user may define the criteria to extract the sales data from the particular region, for a specific time frame, or related to a particular product category.

Once the criteria are set, the data extraction engine 524 is able to access the relevant data within the source ERP application. The data extraction engine 524 then executes the extraction process according to the user's specifications, ensuring that only the data of interest is retrieved. For example, if the user requests sales data for the first quarter of the year for the specific product line, the data extraction engine 524 retrieves only that data from the ERP application. This process ensures that the data extraction is precise and efficient, tailored to the user's needs, and is successfully transferred to the data population platform 310 for further processing or sharing with target devices.

In an example embodiment herein, the data population engine 826, can be configured by the processor 710 to establish the connection between the target electronic device 200 in which the target ERP application 120 is executed, and the data population platform 310, over the network.

The data population engine 826 establishes a robust connection between the target ERP application 120 and the data population platform 310, ensuring that the data population engine 826 is fully compatible with the target ERP system. This compatibility allows the data population engine 826 to populate the database of the target ERP application with the relevant data extracted from various sources. For example, if the user requests to populate sales data for a specific product line from the extracted data, the data population engine 826 will receive this data from the platform and ensure that it is accurately transferred and inserted into the appropriate tables or fields in the target ERP application's database. The data population engine 826 is designed to handle data in various formats, ensuring smooth integration and correct population into the target system. Once the data is populated, the data population engine 826 performs the necessary updates, ensuring that the target ERP application is up to date with the most current and accurate information. This process is vital for maintaining the integrity and relevance of the data within the target application, supporting real-time reporting, analysis, and decision-making across the business.

In an example embodiment herein, the data synchronization engine 828 can be configured by the processor 710 to set up a data synchronization process based on the user input to keep the target ERP application 120, thereby the target electronic device 200 is synchronized, with the source ERP application 110.

In another words, the data synchronization engine 828 sets up the synchronization process to ensure that the target application remains in sync with the source application based on user-defined requirements. This process includes synchronization of various elements such as configuration settings, customizations, application enhancements, and any manual configurations made on either system.

For instance, if the user requests that the target application be kept synchronized with the source application for any new configuration changes, the data synchronization engine 828 continuously monitors and detects updates or modifications made on the source system. When the configuration change or enhancement (e.g., a new feature or module update) is made in the source application, the synchronization engine 828 detects the change and automatically applies the same updates to the target application.

Additionally, if there are manual configurations made on the source application such as user-specific settings or custom workflows, the engine 828 ensures that these are mirrored on the target application, so the two systems are always aligned. This process helps prevent discrepancies between the source and target applications, ensuring that both systems remain consistent and up to date, supporting smooth operations and seamless user experiences across all connected devices and platforms.

In an embodiment herein, the data confirmation engine 830 can be configured by the processor 710 to generate one or more custom control reports corresponding to the set of populated ERP data and the set of extracted ERP data. Further, the data confirmation engine 830 can be configured to confirm the data parity between the source electronic device 100 and the target electronic device 200 based on the report. The data confirmation engine 830, further can be configured to automate an alert in case of a data parity issue or discrepancy. In an example embodiment herein, the data confirmation engine 830 can be configured to determine data parity between the source electronic device 100 and the target electronic device 200 by comparing the set of ERP data extracted and the set of ERP data populated.

For example, consider a scenario where a company needs to synchronize inventory data across different regions. The source electronic device 100, located in the company's warehouse in California, holds the master ERP data, which includes inventory quantities, product information, and supplier details. The target electronic device 200, used by warehouse employees in New York, needs to maintain an up-to-date copy of this data.

The data confirmation engine 830 generates control reports for both the extracted ERP data (from California) and the populated ERP data (on the New York device). The data confirmation engine 830 then compares both data sets to ensure they match, checking for discrepancies such as missing records, mismatched quantities, or incorrect product information.

If any discrepancies or data parity issues are detected during the comparison, the data confirmation engine 830 is configured to automatically trigger the alert, notifying the user or system administrator of the issue. For instance, if the inventory quantity for a specific product is inconsistent between the two devices, the data confirmation engine 830 will alert the user with a message like “Data parity issue detected: Inventory data mismatch between the source and target devices for Product XYZ.”

This process ensures that the data on both devices remains synchronized and accurate, and helps prevent errors that could impact business operations, such as incorrect stock levels or order fulfillment issues. The automation of these checks and alerts significantly reduces manual oversight, improving the overall efficiency and accuracy of the system.

In an embodiment herein, the error handling and control engine 832 can be configured by the processor 710 to manage the data parity during the population or any error in populating of the set of extracted ERP data to the target electronic device 200.

Although FIG. 8 shows various hardware components of the data population platform 310 but it is to be understood that other embodiments are not limited thereon. In other embodiments, the data population platform 310 may include less or more number of components. Further, the labels or names of the components are used only for illustrative purposes and does not limit the scope of the invention. One or more components can be combined together to perform the same or substantially similar function in the data population platform 310.

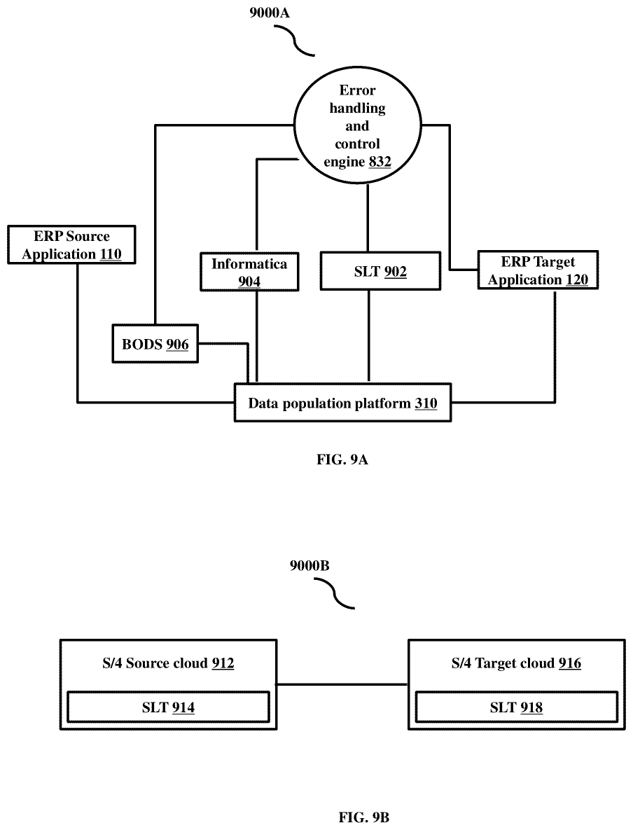

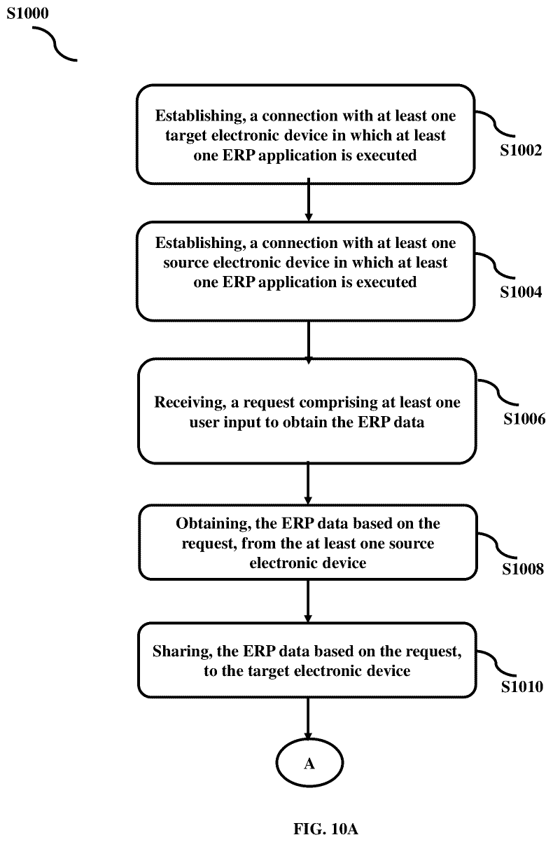

FIG. 9A depicts an example system 9000A for populating the set of ERP data of interest by the data population platform 310, using one or more additional intermediate data filtration engines, according to embodiments as disclosed herein.

The system 9000A may comprise the source ERP application 110, the target ERP application 120, the data population platform 310, and one or more intermediate data filtration engines such as, an ERP landscape transformation replication engine 902, an informatica engine 904, and an ERP business objects data services (ERP BODs) 906. Further, the system 9000A can comprise, an error handling and control engine 832 (explained in FIG. 8) associated with the target ERP application 120 for managing the error while populating of the ERP data of interest extracted from the source electronic device 100. In another embodiment, the system 9000A may comprise the error handling and control engine 832 associated with the one or more intermediate data filtration engines, for managing the error while populating the set of ERP data extracted from the source electronic device 100. In an embodiment here, the data population platform 310 can receive the request including the user input through the target ERP application 120 from the target electronic device 200, and can perform the filtering criteria to extract the ERP data from the source electronic device 100 through the source ERP application 110. In an embodiment herein, the filtering criteria can include performing information handling of the set of extracted ERP data through the intermediate engines prior to populating the extracted ERP data to the target electronic device 200 through the target ERP application 120.

FIG. 9B depict an example block diagram of the system 9000B for handling ERP data in an ERP S/4 could based environment, according to embodiments as disclosed herein. The system 9000B comprises the S/4 source cloud 912 comprising the SLT 914, and the S/4 target cloud 916 comprising an SLT 916. The S/4 source cloud 912 and the S/4 target cloud 916 are communicably connected over the network. Further, the operations and the functions of the system 9000B is similar to the system 9000A which is already explained in FIG. 9A. For the sake of brevity, we are not repeating the same operation in the patent disclosure.

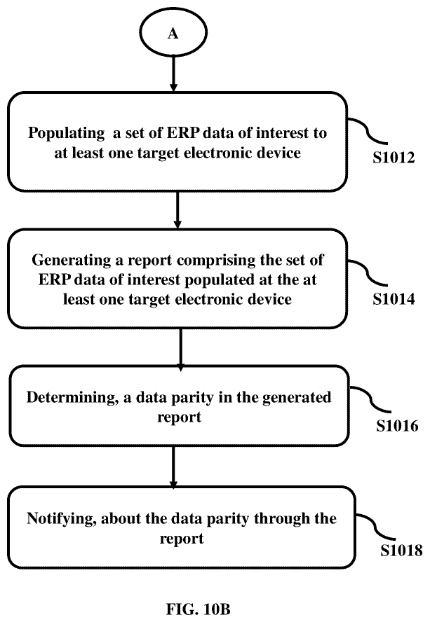

FIG. 10A and FIG. 10B depicts the method S1000 for populating the set of ERP data to the at least one target source device 200, wherein the set of ERP data is received by the data population platform 310 from the source electronic device 200, according to embodiments as disclosed herein.

At step S1002, the method includes establishing, by the data population platform 310, the connection with the at least one target electronic device 200 in which at least one target ERP application 120 is executed.

At step S1004, the method comprises, receiving by the data population platform 310, the request comprising at least one user input from the at least one target electronic device to extract the ERP data, from at least one source electronic device 100, in which the source ERP application 110 is executed. In an embodiment herein, the user input further includes a frequency of accessing the source electronic device 100. In an embodiment herein, the at least one user input corresponds to obtain the subset of ERP data from the complete ERP data. In another embodiment, the at least one user input corresponds to obtain the complete ERP data from the at least one ERP application.

At step S1006, the method comprises, establishing, by the data population platform 310, the connection with at least one source electronic device 100 in which at least one ERP application is executed. At step S1008, the method comprises, obtaining, by the data population platform 310, the set of ERP data, from the at least one source electronic device 100 based on the request.

At step S1010, the method comprises, sharing by the data population platform 310, the extracted ERP data to the at least one target electronic device 200.

At step S1012, the method comprises, populating by the data population platform 310, a set of ERP data to at least one target electronic device 200, wherein the set of ERP data is obtained from the source electronic device 100.

At step S1014, the method comprises, generating by the data population platform 310, a report comprising the set of ERP data populated at the at least one target electronic device. At step 1016, the method comprises, determining, by the data population platform 310 a data parity in the report generated. In an example embodiment herein, an alert is generated for a data parity determined by the data population platform 310.

At step 1018, the method comprises, notifying, by the data population platform 310, the data parity, to a user of the target electronic device 200, through the report. In an embodiment herein, the data parity is notified to the target electronic device 200 through communicating the generated alert.

Embodiments herein disclose, a method for data extraction and population from the source ERP application 110 to the target ERP application 120 using the system 1000 of the present invention includes the steps of:
1. Determining by the data population platform 310 the source ERP application, based on a user input.
2. Configuring by the data population platform 310, the target application 120 by calculating its capacity of accepting data based on the user defined criteria for data filtration from the source application 110.
3. Receiving by the data population platform 310 user inputs regarding the set of data to be extracted from the source ERP application.
4. Establishing by the data population platform 310, connectivity between the source ERP application and the selected by the data population platform 310 to receive the data of interest from the source ERP application based on the user defined criteria and extracting the data.
5. Establishing by the data population platform 310 connectivity between the target ERP application and the by the data population platform 310 to populate the data of interest to the database of the target ERP application and population of extracted data using the data population module.
6. Updating by the data population platform 310 the target application configuration for populating ERP data from the source application based on the user defined criteria.
7. Synchronizing by the data population platform 310 the target ERP application 120 with the source ERP application 110.
8. Generating by the data population platform 310 custom control reports to confirm the data parity between the source ERP application 110 and the target ERP application 120 to automate an alerting mechanism in case of any data parity issues.

The various actions in method S1000 may be performed in the order presented, in a different order or simultaneously. Further, in some embodiments, some actions listed in FIG. 10A-FIG. 10B may be omitted.

FIG. 11A-FIG. 11B is an example table proving an example scenario in relation to handling of the ERP data between the source electronic device 100, and the target electronic device 200. The target electronic device 200 located at a location in India (say), and the source electronic device 100 located at USA. The data population platform 310 receives the request from the target electronic device 200 for ERP data corresponding to sales data for vehicles for specific brands from multiple brands for a time period 3 Mar. 2025-31 Mar. 2025. FIG. 11A is ERP data stored in a database at the source electronic device 100.

FIG. 11B is the ERP data extracted by the data population platform 310 from the source electronic device 100 and populated data population platform 310 in the database at the target electronic device 200.

The connectivity is established by the data population platform 310 between the source ERP application 110 and the data population platform 310 and the ERP data is extracted from the source ERP application 110 based on the user defined criteria. The target ERP application 120 is of the same version of the source ERP application 110. The connectivity is established between the data population platform 310 and the target ERP application 120 for populating the extracted ERP data into the target ERP application 120. The target ERP application 120 can be hosted anywhere in the world and the type of connectivity depends on location of the target ERP application 120.

The target ERP application configuration is updated to accept data from the source ERP application 110 based on the user defined criteria like restarting the document numbers or using the source application document numbers as is. The process is set up to synchronize the target ERP application with the source ERP application for configuration, customization, enhancements, and manual configuration using the data synchronization module. Further, custom control reports are generated by the data population platform 310, to confirm data parity between the source ERP application 110 and the target ERP application 120 and automate an alerting mechanism is generated in case of any data parity issues in the custom control reports. The target application can be set to active or read only based on user requirements. The target ERP application is configured to be hosted on any data center, cloud, the target ERP application can also be hosted/implemented at any third party interface.

The above description is only for the purpose of illustrating the present invention and is not to be construed as limiting the invention, and any modifications, equivalents, improvements and the like that fall within the scope and principle of the present invention are intended to be included therein.

The embodiments disclosed herein can be implemented through at least one software program running on at least one hardware device and performing network management functions to control the network elements. The elements include blocks which can be at least one of a hardware device, or a combination of hardware device and software module.

Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

What is claimed:

1. A method for handling Enterprise Resource Planning (ERP) data, comprising:
establishing, by a data population platform, a connection with at least one source electronic device in which at least one ERP application is executed;
establishing, by the data population platform, a connection with at least one target electronic device in which at least one ERP application is executed;
receiving, by the data population platform, a request comprising at least one user input from the at least one target electronic device to obtain the ERP data from the at least one source electronic device;
obtaining, by the data population platform, the ERP data from the at least one source electronic device based on the request; and
sharing, by the data population platform, the ERP data to the at least one target electronic device.

2. The method as claimed in claim 1, wherein the method comprises:
synchronizing, by the data population platform, the ERP data between the at least one source electronic device and the at least one target electronic device, wherein the synchronization is done based on the at least one user input to keep the at least one target application synchronized with the at least one source application for configuration, customization, enhancements, and manual configuration of the at least one target electronic device, wherein the synchronizing is performed at least one of: a near-real time and a predefined time; and
generating, by the data population platform, a report comprising the ERP data at the at least one target electronic device.

3. The method as claimed in claim 2, wherein the method comprises:
determining, by the data population platform, a data parity in the report; and
notifying, by the data population platform, a user about the data parity.

4. The method as claimed in claim 1, wherein the method comprises:
synchronizing, by the data population platform, the ERP data between the at least one source electronic device and the at least one target electronic device, wherein the synchronization is done based on the at least one user input to keep the at least one target application synchronized with the at least one source application for configuration, customization, enhancements, and manual configuration of the at least one target electronic device;
determining, by the data population platform, a data parity between the at least one source electronic device and the at least one target electronic device; and
notifying, by the data population platform, a user about the data parity.

5. The method as claimed in claim 1, wherein the data population platform shares the ERP data to the at least one target electronic device prior to the at least one target electronic device is configured by computing a size of the ERP data based on the at least one user input for data filtration from the at least one source electronic device.

6. The method as claimed in claim 1, wherein obtaining, by the data population platform, the ERP data from the at least one source electronic device based on the request comprises:
determining, by the data population platform, a filtering criteria associated with the at least user input;
determining, by the data population platform, a frequency of accessing the at least one source electronic device;
determining, by the data population platform, at least one compatibility of operating the at least one source electronic device with the at least one target electronic device;
obtaining, by the data population platform, the ERP data from the at least one source electronic device upon determining the filtering criteria associated with the at least user input, a frequency of accessing the at least one source electronic device, and at least one compatibility of operating the at least one source electronic device with the at least one target electronic device.

7. The method as claimed in claim 1, wherein the at least one user input corresponds to obtain a subset ERP data from a complete ERP data, wherein the at least one user input corresponds to obtain a complete ERP data from the at least one ERP application.

8. The method as claimed in claim 1, wherein the at least one source electronic device comprises at least one of: a main productive source electronic device, a disaster recovery system, a fail over system, high availability source electronic device, wherein the at least one target electronic device is active or read only.

9. The method as claimed in claim 1, wherein the ERP data comprises at least one of: an SAP data, an Oracle® ERP data, and a Microsoft® Dynamics data, wherein the ERP application includes at least one of: an SAP application, an Oracle® ERP application, and a Microsoft® Dynamics application.

10. The method as claimed in claim 9, wherein the at least one SAP application corresponds to at least one of: a SAP ERP, SAP S/4HANA, a SAP Business One, a SAP Business ByDesign, SAP SuccessFactors, SAP Ariba, SAP Concur, SAP Hybris, SAP Analytics Cloud, SAP Leonardo, SAP Fiori, SAP BW/4HANA, SAP NetWeaver, SAP ECC, a SAP S/4 On-premises, SAP S/4 on private Cloud and SAP S/4 on public cloud.

11. An electronic device for handling Enterprise Resource Planning (ERP) data, comprising:
a processor;
a processor; and
a data population platform, coupled with the processor and the processor, configured to
establish a connection with at least one source electronic device in which at least one ERP application is executed;
establish a connection with at least one target electronic device in which at least one ERP application is executed;
receive a request comprising at least one user input from the at least one target electronic device to obtain the ERP data from the at least one source electronic device;
obtain the ERP data from the at least one source electronic device based on the request; and
share the ERP data with the at least one target electronic device.

12. The electronic device as claimed in claim 11, wherein the data population platform is configured to:
synchronize the ERP data between the at least one source electronic device with at least one target electronic device, wherein the synchronization is done based on the at least one user input to keep the at least one target application synchronized with the at least one source application for configuration, customization, enhancements, and manual configuration of the at least one target electronic device, wherein the synchronizing is performed at least one of: a near-real time and a predefined time; and
generate a report comprising the ERP data at the at least one target electronic device.

13. The electronic device as claimed in claim 12, wherein the data population platform is configured to:
determining, by the data population platform, a data parity in the report; and
notifying, by the data population platform, a user about the data parity.

14. The electronic device as claimed in claim 11, wherein the data population platform is configured to:
synchronize the ERP data between the at least one source electronic device and the at least one target electronic device, wherein the synchronization is done based on the at least one user input to keep the at least one target application synchronized with the at least one source application for configuration, customization, enhancements, and manual configuration of the at least one target electronic device;
determine a data parity between the at least one source electronic device and the at least one target electronic device; and
notify a user about the data parity.

15. The electronic device as claimed in claim 11, wherein the data population platform shares the ERP data to the at least one target electronic device prior to the at least one target electronic device is configured by computing a size of the ERP data based on the at least one user input for data filtration from the at least one source electronic device.

16. The electronic device as claimed in claim 11, wherein obtain the ERP data from the at least one source electronic device based on the request comprises:
determine a filtering criteria associated with the at least user input;
determine a frequency of accessing the at least one source electronic device;
determine at least one compatibility of operating the at least one source electronic device with the at least one target electronic device;
obtain the ERP data from the at least one source electronic device upon determining the filtering criteria associated with the at least user input, a frequency of accessing the at least one source electronic device, and at least one compatibility of operating the at least one source electronic device with the at least one target electronic device.

17. The electronic device as claimed in claim 11, wherein the at least one user input corresponds to obtain a subset ERP data from a complete ERP data, wherein the at least one user input corresponds to obtain a complete ERP data from the at least one ERP application.

18. The electronic device as claimed in claim 11, wherein the at least one source electronic device comprises at least one of: a main productive source electronic device, a disaster recovery system, a fail over system, high availability source electronic device, wherein the at least one target electronic device is active or read only.

19. The electronic device as claimed in claim 11, wherein the ERP data comprises at least one of: an SAP data, an Oracle® ERP data, and a MicroSoft® Dynamics data, wherein the ERP application includes at least one of: an SAP application, an Oracle® ERP application, and a Microsoft® Dynamics application.

20. The electronic device as claimed in claim 19, wherein the at least one SAP application corresponds to at least one of: a SAP ERP, SAP S/4HANA, a SAP Business One, a SAP Business ByDesign, SAP SuccessFactors, SAP Ariba, SAP Concur, SAP Hybris, SAP Analytics Cloud, SAP Leonardo, SAP Fiori, SAP BW/4HANA, SAP NetWeaver, SAP ECC, a SAP S/4 On-premises, SAP S/4 on private Cloud and SAP S/4 on public cloud.

21. The electronic device as claimed in claim 11, wherein the data population platform comprises:
a data customization engine configured to receive at least one user input based on which a set of data to be extracted from a source EPR application is filtered;
a data extraction engine configured to establish a connectivity between a source ERP application over a network, and extract the ERP data of interest from the source ERP application based on a user defined criteria,
a data population engine configured to establish a connectivity between a target ERP application over the network, and populate the ERP data of interest in a database of the target ERP application,
a data synchronization engine configured to setup a process based on the user requirement to keep a target application synchronized with a source application for configuration, customization, enhancements, and manual configuration, and
a data confirmation engine configured to generate custom control reports to confirm the data parity between the source ERP application and the target ERP application to automate the alerting mechanism in case of any data parity issues or discrepancy.
